(19) United States
(12) Patent Application Publication
(10) Pub. No.: US 2009/0234886 A1
(43) Pub. Date: Sep. 17, 2009

(54) Apparatus and Method for Arranging Metadata

(76) Inventor: Gopalakrishna Raghavan, Winchester, MA (US)

Correspondence Address: Nokia, Inc., 6021 Connection Drive, MS 2-5-520, Irving, TX, 75039, US

(21) Appl. No.: 12/045,806

(22) Filed: Mar. 11, 2008

(51) Int. Cl. G06F 17/30

(52) U.S. Cl. 707/104.1; 707/E17.001

(57) ABSTRACT

In accordance with an exemplary embodiment of the present invention, an apparatus for metadata arrangement is disclosed. The apparatus comprises a computer computer code configured to assign at least one metadata element identifier to at least one metadata element, a computer code configured to classify the at least one metadata element into at least one category, a computer code configured to assign at least one category identifier to the at least one category, a computer code configured to associate the at least one metadata element to the at least one category identifier, and a computer code configured to associate the at least one category identifier to at least one segment of multimedia data.

### TECHNICAL FIELD

The present application relates generally to multimedia content description and more particularly to an apparatus and method for arranging metadata.

### BACKGROUND

Multimedia content is usually compressed into standardized bit-stream formats. Compressed audio formats may be MP3 (MPEG-1 Audio Layer 3), AAC (Advanced Audio Coding) and/or the like. Video coding standards may be MPEG-2, H.263, MPEG-4 part 2 and AVC (Advanced Video Coding) also known as H.264 or MPEG-4 part 10 and/or the like. The compression of multimedia content usually results in a significant reduction in file size and therefore facilitates the storage and transmission of audio-visual content. Compressed bitstream formats may be decompressed by a decoder for access or playback.

MPEG-7 is an ISO/IEC standard developed by MPEG (Moving Picture Experts Group) and is formally named “Multimedia Content Description Interface”. MPEG-7 offers a wide set of standardized tools to describe multimedia content. Such tools comprise Descriptors (D) that define the syntax and the semantics of each feature, e.g. metadata elements, and Description Schemes (DS) that specify the structure and the relationship between different components. The scope of MPEG-7 also includes Description Definition Language (DDL) defining the syntax of MPEG-7 description tools and system tools to support binary coded representation.

Metadata residing on many music CDs (compact discs) or movie DVDs (Digital Versatile Discs) might include information like track number, chapter number, title, album, artist etc., and indices that point to specific bit positions or slices in the bit stream. Such indices may allow accessing media data at chapter or track level. Metadata information might be encoded in the content header or supplied as separate hash table that index into the bit stream.

### SUMMARY

In accordance with an exemplary embodiment of the present invention, an apparatus comprising a processor and a memory unit communicatevily coupled to the processor. The apparatus comprises a computer code configured to assign at least one metadata element identifier to at least one metadata element, a computer code configured to classify the at least one metadata element into at least one category, a computer code configured to assign at least one category identifier to the at least one category, a computer code configured to associate the at least one metadata element identifier to the at least one category identifier; and a computer code configured to associate the at least one category identifier to at least one segment of multimedia data.

In accordance with another exemplary embodiment of the present invention, an apparatus comprising a processor and a memory unit communicatevily coupled to the processor and comprising computer code configured to process metadata, corresponding to multimedia data, wherein the metadata is arranged into at least one metadata element having at least one metadata element identifier associated with it, at least one category having at least one category identifier associated with it, wherein the at least one category comprises the at least one metadata element, and at least one data structure indicating an association between the at least one metadata element identifier and the at least one category identifier.

In accordance with another exemplary embodiment of the present invention, a method for arranging metadata comprising assigning at least one metadata element identifier to at least one metadata element, classifying the at least one metadata element into at least one category, assigning at least one category identifier to the at least one category, associating the at least one metadata element identifier to the at least one category identifier, and associating the at least one category identifier to at least one segment of multimedia data.

In accordance with another exemplary embodiment of the present invention, a method of identifying at least one segment of multimedia data associated with at least one keyword comprises identifying at least one metadata element identifier corresponding to at least one metadata element, wherein one or more of the at least one metadata element comprises at least one keyword, determining at least one category identifier associated with the at least one metadata element identifier, and identifying at least one segment of multimedia data associated with the at least one category identifier.

In accordance with another exemplary embodiment of the present invention, a computer program product comprising a computer-readable medium bearing computer program code embodied therein for use with a computer, the computer program code comprises a code for assigning at least one metadata element identifier to at least one metadata element, a code for classifying the at least one metadata element into at least one category, a code for assigning at least one category identifier to the at least one category, a code for associating the at least one metadata element identifier to the at least one category identifier, and a code for associating the at least one category identifier to at least one segment of multimedia data.

In accordance with another exemplary embodiment of the present invention, a computer program product comprising a computer-readable medium bearing computer program code embodied therein for use with a computer, the computer program code comprises a code for accessing metadata, corresponding to multimedia data, wherein the metadata comprises at least one metadata, wherein said at least one metadata element has at least one metadata element identifier associated with it and comprises at least one keyword, at least one category, wherein the at least one category has at least one category identifier associated with it and comprises at least one metadata element, and at least one data structure indicating coupling between the at least one metadata element identifier and the at least one category identifier. The computer code also comprises a code for identifying at least one multimedia segment associated with the at least one keyword, based at least in part on the at least one data structure indicating coupling between the at least one metadata element identifier and the at least one category identifier.

### BRIEF DESCRIPTION OF THE DRAWINGS

For a more complete understanding of exemplary embodiments of the present invention, the objects and potential advantages thereof, reference is now made to the following descriptions taken in connection with the accompanying drawings in which:

FIG. 1 is an overview diagram of an exemplary system within which embodiments of the present invention may be implemented;

FIG. 2 is a perspective view of an exemplary apparatus within which embodiments of the present invention may be implemented;

FIG. 3 is a schematic diagram of an exemplary circuitry of the apparatus of FIG. 2;

FIG. 4 is a flow chart of a method for arranging metadata according to an exemplary embodiment of the present invention;

FIG. 5 is a block diagram of an exemplary arrangement of metadata into metadata elements and categories;

FIG. 6 is a flow chart of a method for identifying segments in a multimedia file in accordance with an exemplary embodiment of the present invention;

FIG. 7 is an exemplary system illustrating the distribution of metadata elements and MetaIndex structures; and

FIG. 8 is an exemplary bitstream embedded with MetaIndex information in accordance with an exemplary embodiment of the present invention.

### DETAILED DESCRIPTION OF THE DRAWINGS

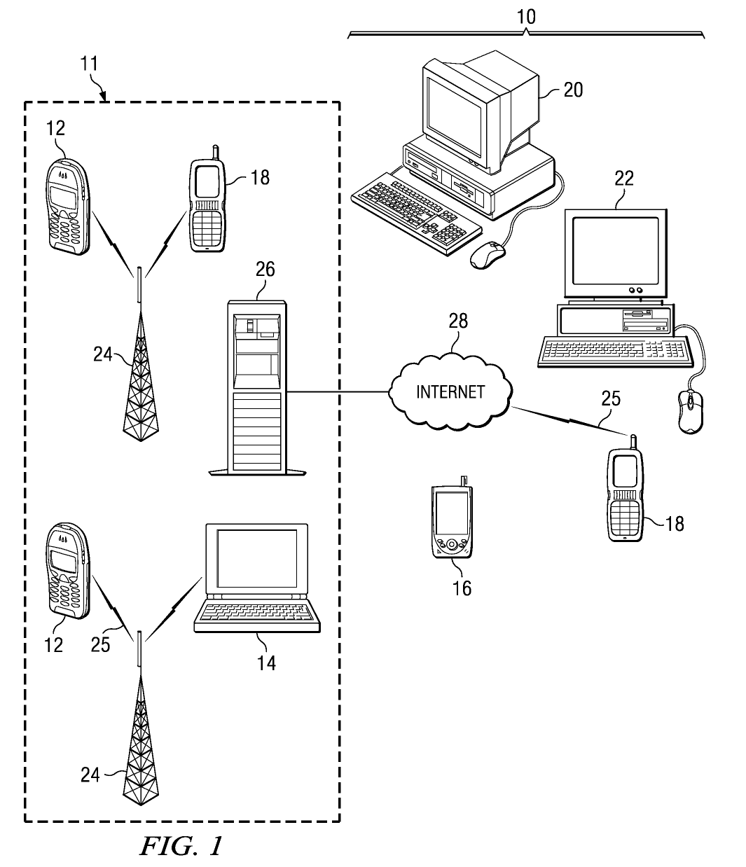

An exemplary embodiment of the present invention and its potential advantages are best understood by referring to FIGS. 1 through 8 of the drawings, like numerals being used for like and corresponding parts of the various drawings.

FIG. 1 is an overview diagram of an exemplary system 10 within which embodiments of the present invention may be implemented. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For example, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, TV broadcasting, and the like.

The exemplary communication devices of the system 10 may include, but are not limited to, a combination of personal digital assistant (PDA) and mobile phone 14, a mobile phone 12, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be coupled to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

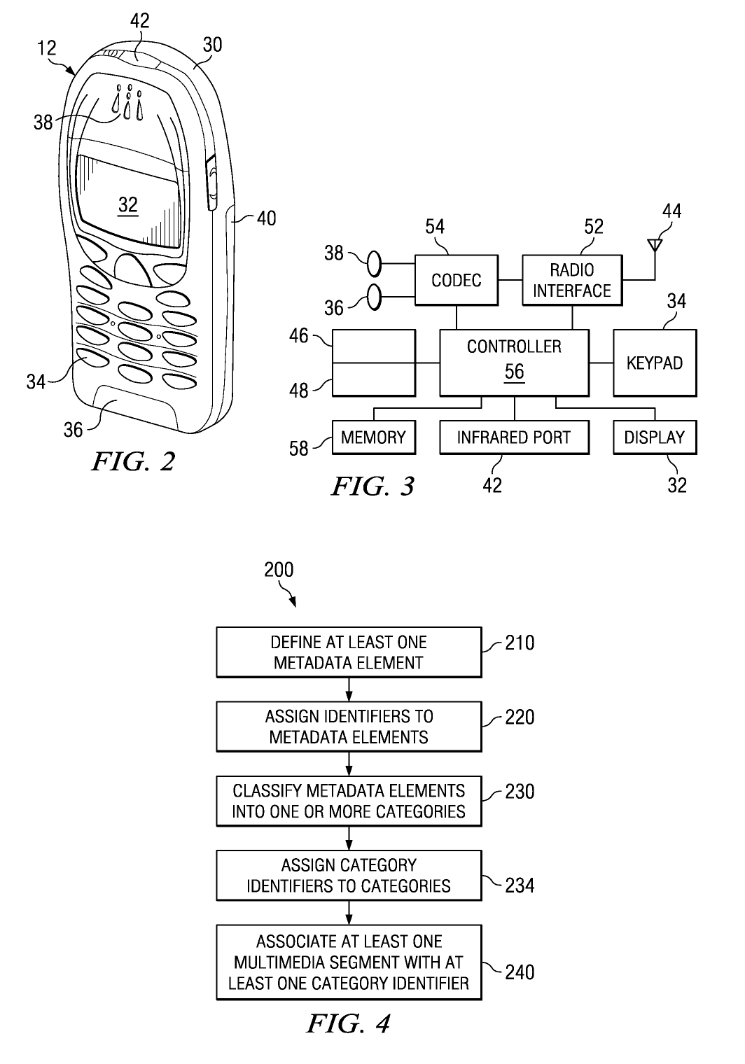

FIG. 2 is a perspective view of an exemplary apparatus within which embodiments of the present invention may be implemented and FIG. 3 is a schematic diagram of an exemplary circuitry of the apparatus of FIG. 2. It should be understood, however, that the present invention is not intended to be limited to one particular type of mobile device 12 or other electronic device. Some or all of the features depicted in FIGS. 2 and 3 may be incorporated into any or all of the devices represented in FIG. 1. The mobile device 12 of FIGS. 2 and 3 comprises a housing 30, a display 32, a keypad 34, a microphone 36, an ear-piece 38, a battery 40, an infrared port 42, an antenna 44, a smart card 46 according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

There is a significant amount of digital audio-visual content that is available on the internet, in broadcast data streams, in personal and professional databases and/or the like. Users, consuming or using such multimedia content, may benefit from a mechanism to efficiently and accurately access content based on personal preferences. In other words, given the large amount and possibly the length of available content, professionals as well as end users would like to be able to easily identify, manage, browse, retrieve, edit and/or selectively playback such content based on personal preferences or needs. Due to the abstraction of the compressed formats, metadata may be used to describe the content of multimedia files, the date of creation/production, the nature of content, e.g. private or public, copyright information, etc.

At least one embodiment for handling metadata, for example, creating, arranging, indexing, storing, searching, etc., is described. A multimedia file or sequence, e.g. video, audio, graphics, etc., may be divided into one or more segments. Examples of a multimedia segment comprise a slice, a frame, a scene, a set of consecutive frames, a portion of a bitstream corresponding to the multimedia file and/or the like. According to an exemplary embodiment, metadata is defined and indexed for segments of a multimedia file. An exemplary embodiment of the present invention allows efficient access, selective playback, editing, processing, etc., of one or more segments of a multimedia file based at least in part on metadata information. According to an exemplary embodiment, metadata may be efficiently arranged, indexed and coded.

FIG. 4 is a flow chart of a method 200 for arranging metadata according to an exemplary embodiment of the present invention. According to this exemplary embodiment, metadata may be associated with at least one multimedia segment. At block 210, at least one metadata element is defined or selected. A metadata element may partially or fully describe the content of at least one multimedia segment. One or more metadata elements may be associated with one multimedia segment. A metadata element may comprise at least one keyword. At block 220, an identifier, for example a metadata element identifier (MEID), is assigned to metadata elements. An MEID may be a number, a symbol, and/or the like. In an exemplary embodiment, an MEID is unique to a metadata element. However, if desired in other embodiments, an MEID may be assigned to more than one metadata element. At block 230, the metadata elements may be classified into at least one category. At block 234, a category identifier (CID) is assigned to at least one category. In an exemplary embodiment each category has a unique CID. However, if desired in an exemplary embodiment, a CID may be assigned to more than one category. According to another exemplary embodiment, each category is associated with a CID. However, other exemplary embodiments where not all categories have CIDs assigned to them may also be possible. At block 240, at least one multimedia segment is marked or associated with at least one category identifier. In an exemplary embodiment, a CID associated with, or used to mark, a multimedia segment corresponds to a category that includes at least one metadata element with at least one keyword describing the content of the associated multimedia segment. The association between multimedia segments and CIDs may be based on content analysis of the multimedia segments. According to an exemplary embodiment, one or more multimedia segments may not have CIDs assigned to them.

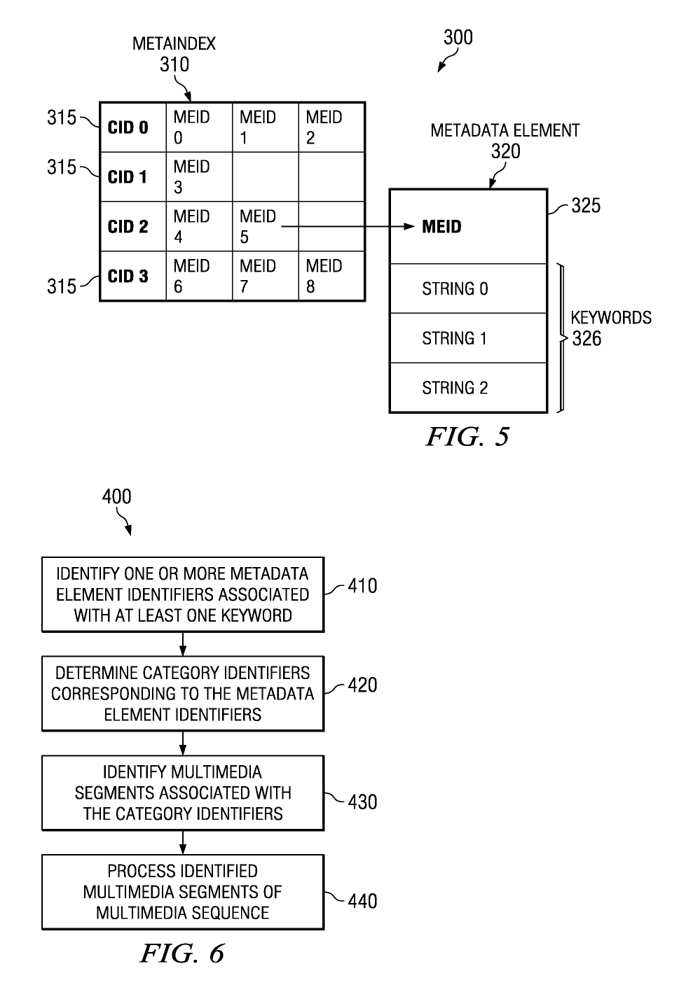

FIG. 5 is a block diagram of an exemplary arrangement of metadata into one or more metadata elements and one or more categories. According to this exemplary embodiment, a metadata element 320 comprises at least one keyword 326. A keyword may be a string, a number, and/or the like. A metadata element 320 may be referenced by a MEID 325. In the embodiment of FIG. 5, MEID 325 is part of the metadata element 320. However, if desired in another exemplary embodiment, MEID 325 may be separate from metadata element 320. According to an exemplary embodiment, one or more MEIDs 325 may be associated with a CID 315. A MetaIndex table 310 may be used to relate one or more MEIDs 325 to one or more CIDs 315. In the example of FIG. 5, each row of the MetaIndex table 310 may correspond to a CID 315. The column elements in each row correspond to one or more MEIDs 325 associated with the CID 315 of the same row.

Different implementations of the structure relating one or more MEIDs 325 to one or more CIDs 315 are also possible. Such implementations comprise, for example, trees, tables or other data structures that might be defined within a computer code. In an exemplary embodiment, it may be possible that one or more MEIDs 325 and/or one or more CIDs 315 may be predefined such that one or more MEIDs 325 have no keywords 326 associated with them. Similarly, one or more CIDs 315 may not have MEIDs 325 associated with them.

According to an exemplary embodiment of the present invention, a category may represent information about the content of a multimedia file. For example, for a multimedia file a category may be type of event, player(s), actor(s), mood and/or the like, in multimedia segments. For an audio segment, a category may refer to speech, conversation, noise, and the like. According to another exemplary embodiment, a category may simply represent a set of metadata elements, e.g., keywords 326 that may not have a meaningful correlation.

In an exemplary embodiment, the method 200 for arranging metadata is preceeded by a content analysis of the multimedia file. The content analysis may summarize or classify the content of a multimedia segment into one or more keywords. The keywords corresponding to the multimedia segments may then be arranged into metdata elements. The metadata elements may be identified with MEIDs 325. The metadata elements may be arranged or classified into one or more categories. Categories may be identified with CIDs 315. Based on the keywords associated with each metadata element 320 and the association between a category and corresponding metadata elements 320, categories or CIDs 315 may be associated to multimedia segments. In an exemplary content-based search or access of multimedia segments, for example, keywords may then be traced back to one or more corresponding multimedia segments through the coupling or association between keywords and metadata elements, the coupling between metadata elements and categories, and the coupling between categories and multimedia segments. The metdata arrangement may be performed by the producer or creator of the multimedia file, a service provider, an end user, or any other entity.

FIG. 6 is a flow chart of a method 400 for identifying segments in a multimedia file in accordance with an exemplary embodiment of the present invention. According to this exemplary embodiment, segments in a multimedia file or bitstream that may be relevant based on at least one metadata element, for example a keyword, are identified.

At block 410, one or more MEIDs 325, associated with one or more metadata elements 320 that include at least one keyword 326, are identified. The keywords may be provided for example by a user. Then, the metadata elements containing those keywords are identified and the MEIDs, corresponding to the identified metadata elements, are determined. At block 420, the CIDs to which the one or more MEIDs belong are determined based, for example, on the MetaIndex table 310, any other used data structure, or any other method. At block 430, the multimedia segments associated with the CIDs 315, to which the MEIDs 325 are matched, are identified. For example, if CIDs are embedded within bitstream portions, corresponding to multimedia segments, the multimedia segments may be identified by parsing the bitstream. In another example, a data structure may indicate the multimedia segments associated with each CID. At block 440, the identified multimedia segments are processed, e.g., by a user, a content provider, a network server, and/or the like. The processing of the multimedia segments comprises play back, editing, storing, transmitting, and possibly other processing operations.

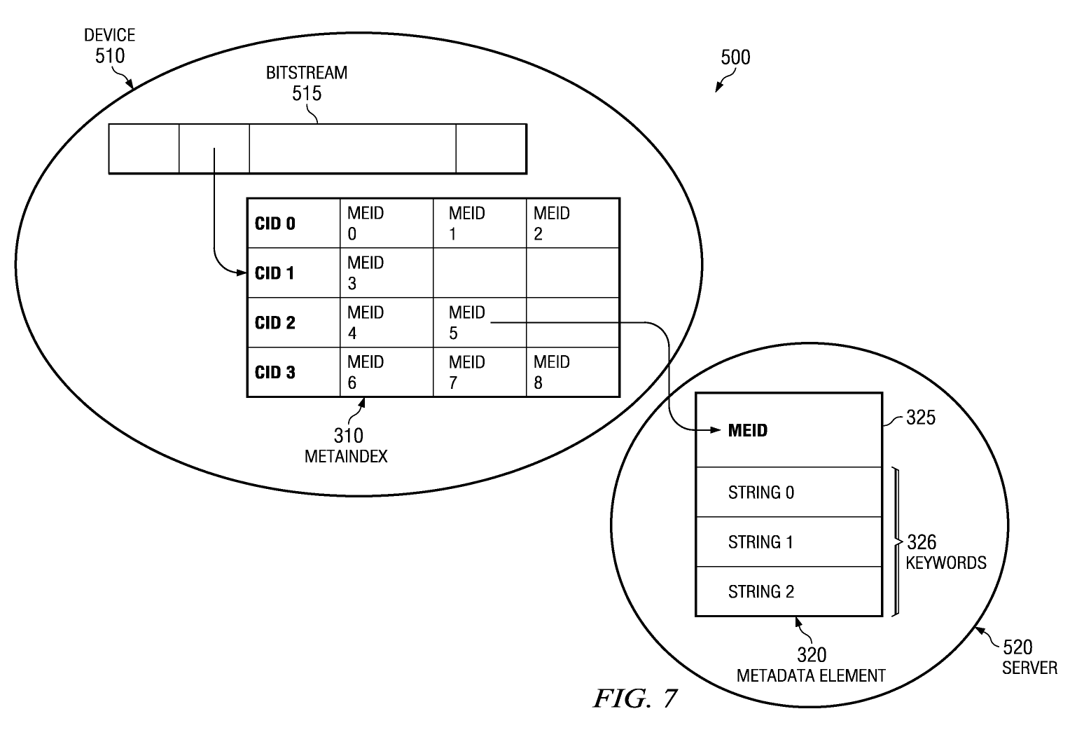

FIG. 7 is an exemplary system illustrating the distribution of metadata elements and MetaIndex structures. According to this embodiment, MetaIndex tables or structures 310 may reside on a user terminal or device 510 whereas the metadata elements 320 may reside on a server 520. Metadata elements 320, comprising keywords 326, with their associated MEIDs 325, may be in a metafile stored on the server 520. According to another embodiment, MetaIndex tables/structures 310 may reside on a server 520 whereas the metadata elements 320 may reside on a user device or terminal 510.

According to yet another exemplary embodiment, metadata elements 320 and MetaIndex table(s) or structure(s) 310 may both be in the same metafile and/or may both reside on the server 520. According to this exemplary embodiment, the association between CIDs 315 and corresponding multimedia segments may be indicated in the same metafile. In another exemplary implementation, CIDs 315 corresponding to a multimedia segment may be embedded in the portion of the bitstream corresponding to the same segment.

According to another embodiment, both metadata elements 320 and MetaIndex table(s) or structure(s) 310 may reside on the user device 510. Different implementations in this case are possible depending at least in part, for example, on which parts are embedded in the bitstream and which parts are located in a metafile.

Multimedia data may be obtained from different sources, e.g., a user device, internet, broadcasted by a provider, and/or the like. The metadata, corresponding to a multimedia file, may also be generated by the multimedia provider, by a user, by the multimedia creator, and the like. Depending at least in part on these scenarios, parts or all of the metadata may be stored on a single or multiple devices.

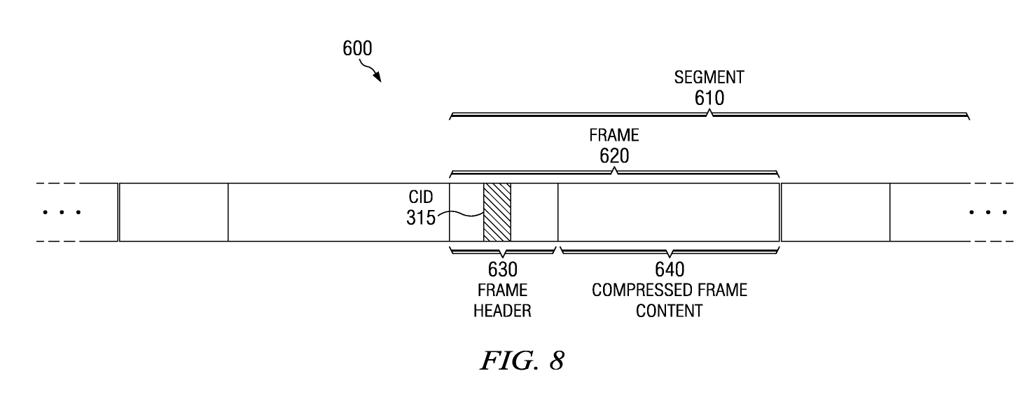

FIG. 8 is an exemplary bitstream 600 embedded with MetaIndex information in accordance with an exemplary embodiment of the present invention. In a multimedia sequence, for example, one or more CIDs 315 associated with a multimedia segment 610 may be embedded within a frame header 630. For example, the frame header may correspond to the first frame, or simply to any frame 620 in the multimedia segment. According to an exemplary embodiment, CID(s) 315 associated with a multimedia segment may be embedded in one or more frame headers 630 corresponding to one or more frames in the segment. MetaIndex table(s) or structure(s), if embedded within bitstream 600, may be located within the bitstream file header or located within other headers. Parts of MetaIndex table(s)/structure(s), e.g., CID(s), or all of MetaIndex table(s)/structure(s) may also be embedded with other sections/parts of a multimedia segment or a multimedia file like supplemental enhancement information

The processes already described with reference to FIG. 4 and FIG. 6 may be performed by a device 510, a server 520 or may be performed as a collaboration by both device 510 and server 520 depending, for example, on the implementation and where different parts of the data reside.

Metadata, according to exemplary embodiments of this invention, may be used by one or more devices processing the metadata. For example, one or more category identifiers and/or one MetaIndex structures may be embedded into or read from a multimedia file, or bitstream. Alternative or additionally, data structures describing the metadata arrangement, CIDs and/or MEIDs may be stored, received, transmitted or communicated by one or more devices. The metadata arrangement, according to exemplary embodiments of the present invention, provides an efficient structure in processes involving content-based search and content-based access of multimedia material. Other processing operations that may involve the described metadata arrangements also comprise editing the metadata and/or editing the metadata arrangement, for example adding, removing and/or modifying metdata elements, categories or the structure describing the coupling or association between such entities. These operations comprise some, but not necessarily all, of the processing operations that might use the metadata arrangement described according to exemplary embodiments of the present invention.

Embodiments of the present invention may be implemented in software, hardware, application logic or a combination of software, hardware and application logic. The software, application logic and/or hardware may reside on server(s), computer(s) or hand-held devices including, but not restricted to cell phones. If desired, part of the software, application logic and/or hardware may reside on chipset(s), part of the software, application logic and/or hardware may reside on network server(s), and part of the software, application logic and/or hardware may reside on user terminal. The application logic, software or an instruction set is preferably maintained on any one of various computer-readable media. In the context of this document, a “computer-readable medium” can be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Without in any way limiting the scope, interpretation, or application of the claims appearing below, it is possible that a technical advantage of one or more of the exemplary embodiments disclosed herein may be efficient content-based selective playback. Another possible technical advantage of one or more of the exemplary embodiments disclosed herein may be reduction in power consumption in processing multimedia data. Another technical advantage of one or more of the exemplary embodiments disclosed herein may be indexing metadata within bitstream without significant overhead in file size.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. An apparatus comprising:
a processor; and
a memory unit communicatevily coupled to the processor and comprising:
computer code configured to assign at least one metadata element identifier to at least one metadata element;
computer code configured to classify said at least one metadata element into at least one category;
computer code configured to assign at least one category identifier to said at least one category;
computer code configured to associate said at least one metadata element identifier to said at least one category identifier; and
computer code configured to associate said at least one category identifier to at least one segment of multimedia data.

2. The apparatus of claim 1, wherein said metadata element identifier is a number.

3. The apparatus of claim 1, wherein said category identifier is a number.

4. The apparatus of claim 1, further comprising computer code configured to classify at least one keyword into said at least one metadata element.

5. The apparatus of claim 1, further comprising computer code configured to form at least one data structure indicating said association between said at least one metadata element identifier and said at least one category identifier.

6. The apparatus of claim 5, wherein said data structure is a table.

7. The apparatus of claim 1, wherein at least one of said at least one metadata element identifier, said at least one category identifier, and said at least one metadata element is stored in the apparatus.

8. The apparatus of claim 5, wherein at least one of said at least one category identifier and said at least one data structure is embedded in a bitstream corresponding to multimedia data.

9. An apparatus comprising:
a processor; and
a memory unit communicatevily coupled to the processor and comprising computer code configured to process metadata, corresponding to multimedia data, wherein said metadata is arranged into:
at least one metadata element having at least one metadata element identifier associated with it;
at least one category having at least one category identifier associated with it, wherein said at least one category comprises said at least one metadata element; and
at least one data structure indicating an association between said at least one metadata element identifier and said at least one category identifier.

10. The apparatus of claim 9, wherein said metadata element identifier is a number.

11. The apparatus of claim 9, wherein said category identifier is a number.

12. The apparatus of claim 9, wherein said data structure is a table.

13. The apparatus of claim 9, wherein at least one of said at least one category identifier and said at least one data structure is embedded in a bitstream corresponding to the multimedia data.

14. A method for arranging metadata, comprising:
assigning at least one metadata element identifier to at least one metadata element;
classifying said at least one metadata element into at least one category;
assigning at least one category identifier to said at least one category;
associating said at least one metadata element identifier to said at least one category identifier; and
associating said at least one category identifier to at least one segment of multimedia data.

15. The method of claim 14, wherein said metadata element identifier is a number.

16. The method of claim 14, wherein said category identifier is a number.

17. The method of claim 14, wherein said segment of multimedia data comprises at least of a frame, a scene or a portion of multimedia data.

18. The method of claim 14, further comprising classifying at least one keyword into said at least one metadata element.

19. The method of claim 14, further comprising forming at least one data structure indicating the association between said at least one metadata element idedentifier and said at least one category identifier.

20. The method of claim 19, wherein at least one of said at least one category identifier and said at least one data structure is embedded in a bitstream corresponding to the multimedia data.

21. A method, comprising:
identifying at least one metadata element identifier corresponding to at least one metadata element, wherein at least one of said at least one metadata element comprises at least one keyword;
determining at least one category identifier associated with said at least one metadata element identifier; and
identifying at least one segment of multimedia data associated with said at least one category identifier.

22. The method of claim 21, wherein said metadata element identifier is a number.

23. The method of claim 21, wherein said category identifier is a number.

24. The method of claim 21, wherein said at least one segment of multimedia data comprises at least one of a frame, a scene or a portion of multimedia data.

25. The method of claim 21, wherein said determining at least one category identifier is based at least in part on at least one data structure indicating coupling between said at least one metadata element identifier and said at least one category identifier.

26. The method of claim 25, wherein at least one of said at least one category identifier and said at least one data structure is embedded in a bitstream corresponding to the multimedia data.

27. A computer program product comprising a computer-readable medium bearing computer program code embodied therein for use with a computer, the computer program code comprising:
code for assigning at least one metadata element identifier to at least one metadata element;
code for classifying said at least one metadata element into at least one category;
code for assigning at least one category identifier to said at least one category;
code for associating said at least one metadata element identifier to said at least one category identifier; and
code for associating said at least one category identifier to at least one segment of multimedia data.

28. A computer program product comprising a computer-readable medium bearing computer program code embodied therein for use with a computer, the computer program code comprising:
code for accessing metadata, corresponding to multimedia data, wherein said metadata comprise;
at least one metadata element, wherein said at least one metadata element has at least one metadata element identifier associated with it and comprises at least one keyword;
at least one category, wherein said at least one category has at least one category identifier associated with it and comprises at least one metadata element; and
at least one data structure indicating coupling between said at least one metadata element identifier and said at least one category identifier; and
code for identifying at least one multimedia segment associated with said at least one keyword, based at least in part on said at least one data structure.
